(19) United States
(12) Patent Application Publication
(10) Pub. No.: US 2020/0258367 A1
(43) Pub. Date: Aug. 13, 2020

(54) A SYSTEM AND METHOD FOR ALERTING A SUPERVISOR OF AN INDIVIDUAL IN DISTRESS

(71) Applicant: Drownsafe LLC, Guilford, CT (US)

(72) Inventor: Sven Jungmar, Spanga (SE)

(21) Appl. No.: 16/753,654

(22) PCT Filed: Oct. 5, 2018
(86) PCT No.: PCT/US2018/054501

§ 371 Date: Apr. 3, 2020

Related U.S. Application Data
(60) Provisional application No. 62/568,499, filed on Oct. 5, 2017.

(51) Int. Cl. G08B 21/08; G08B 29/20; G06F 8/65; G08B 25/10; G08B 6/00; G08B 7/06

(52) U.S. Cl. CPC G08B 21/088; G08B 29/20; G08B 7/06; G08B 25/10; G08B 6/00; G06F 8/65

(57) ABSTRACT

A system and a method for alerting a supervisor of an individual in distress (100) includes a wearable apparatus (10) that communicates with a receiver unit (20). The wearable apparatus (10) has a sensor (40), a signal generator (50), and a power source (60) in a housing (30). The receiver unit (20) receives an alarm signal generated by the signal generator (50). The alarm signal emits at two frequencies. A control unit (55) interprets the data received by the receiver unit (20) and reports a system status to the supervisor. A wall unit (65) communicates with the control unit (55) to display the system status.

### CROSS REFERENCE TO RELATED APPLICATIONS

This application also claims the benefit of U.S. provisional application No. 62/568,499 filed Oct. 5, 2017, which is incorporated herein by reference in its entirety.

### BACKGROUND

Public, hotel, paid attendance, and members-only swimming pools are typically supervised by one or more lifeguards, and/or security staff, or other supervisors to ensure the safety of the swimmers. However, when a pool is understaffed or overcrowded, water quality is low, and/or glare and other adverse environmental factors are present, it becomes difficult for the lifeguards on duty, security personnel, and other supervisors of swimmers to pay sufficient attention to each swimmer. Further, it is unreasonable to expect human lifeguards to provide 100% attention to the swimmers over the course of a shift that can last many hours. Additionally, relying on human performance of drowning detection and prevention is subject to human error. Finally, while a team of lifeguards or security personnel can be economically feasible for public, commercial, and members-only pools that receive sufficient funding, owners of personal home pools and bodies of water are unlikely to pay for or be capable of affording lifeguard services.

There exists a need in the art for a system that alerts a supervisor automatically when an individual is in a variety of distress situations.

### SUMMARY

Some embodiments of the present disclosure are directed to a system and a method for alerting a supervisor of an individual in distress includes a wearable apparatus that communicates with a receiver unit. The wearable apparatus has a sensor, a signal generator, and a power source in a housing. The receiver unit receives an alarm signal generated by the signal generator. The alarm signal emits at two frequencies. A control unit interprets the data received by the receiver unit and reports a system status to the supervisor. A wall unit communicates with the control unit to display the system status.

In some embodiments, a system for alerting a supervisor of an individual in distress includes a wearable apparatus having a housing. The housing includes a sensor, a signal generator, and a power source. A receiver unit communicates with the wearable apparatus and receives an alarm signal that is generated by the signal generator. A control unit communicates with the receiver unit and the supervisor to report a system status to the supervisor. A wall unit communicates with the control unit and displays the system status. The alarm signal emits at least two frequencies.

In some embodiments, the signal generator is a piezoelectric membrane.

In some embodiments, the alarm signal sweeps from a first frequency to a final frequency. In some embodiments, the alarm signal sweeps are repeated until the alarm signal is disabled. In some embodiments, the alarm signal sweeps by increasing or decreasing in discrete frequency increments until a final frequency is reached. In some embodiments, the alarm signal sweeps randomly between frequencies.

In some embodiments, the sensor is a pressure sensor, a temperature sensor, or a combination thereof. In some embodiments, the signal generator is a vibration generator, a sound generator, a piezoelectric membrane, or a combination thereof.

In some embodiments, two or more receiver units communicate with the wearable apparatus.

In some embodiments, an I/O unit communicates with the control unit to generate a visual, aural, or tactile alarm.

In some embodiments, a tester tests battery level, tests software operability, updates wearable apparatus software, updates wearable apparatus settings, or a combination thereof. In some embodiments, the wearable apparatus settings include alarm trigger time and initiating updates to alarm trigger depth.

In some embodiments, a method for alerting a supervisor of an individual in distress includes a system including wearable apparatus and a receiver unit. The wearable apparatus has a signal generator and a battery. The receiver unit receives an alarm signal generated by a signal generator. A control unit communicates with the receiver unit and the supervisor to report a system status to the supervisor. The control unit measures the system status and reports the system status to the supervisor every update period.

In some embodiments, the control unit in the method for alerting a supervisor measures the system status and reports the system status to the supervisor when the system status remains in a depth range for a predetermined period.

In some embodiments, the update period becomes a sleep period if the system status indicates a pressure change measurement and a temperature measurement below a sleep reference. In some embodiments, the sleep period becomes the update period if the system status indicates a positive pressure change or temperature change above a wake reference. In some embodiments, the update period becomes a warning period if the system status indicates a battery voltage level below a warning reference. In some embodiments, the signal generator emits a signal every warning period to the supervisor until the system status indicates a battery voltage level above the warning reference.

In some embodiments, two or more receiver units in the method for alerting a supervisor communicate with the wearable apparatus.

In some embodiments, an I/O unit in the method for alerting a supervisor communicates with the control unit, to generate a visual, aural, or tactile alarm.

In some embodiments, a tester in the method for alerting a supervisor tests battery level, tests software operability, updates wearable apparatus software, updates wearable apparatus settings, or a combination thereof. In some embodiments, the wearable apparatus settings include alarm trigger time and initiating updates to alarm trigger depth.

### BRIEF DESCRIPTION OF THE DRAWINGS

FIG. 1 depicts a flow chart of a system according to this disclosure;

FIG. 2 depicts a perspective view of a wearable apparatus according to the present disclosure;

FIG. 3 depicts a simplified block diagram of the system of FIG. 1;

FIG. 4 depicts a tester/programmer and wearable apparatus according to the present disclosure;

FIG. 5A is a top view of a PC Board included in the wearable apparatus of FIG. 2;

FIG. 5B is a top view of a piezo sounder connected to the PC Board of FIG. 5A;

FIG. 6A is a top view of the piezo sounder inserted into a housing of the wearable apparatus of FIG. 2; and

FIG. 6B is a top view of the PC Board of FIG. 5A installed in the housing of the wearable apparatus of FIG. 2.

### DETAILED DESCRIPTION

Swimmer location systems have been used to help support or replace some aspects of the lifeguard team, alerting a supervising individual that a swimmer may be in distress. However, previous systems have had significant difficulties accounting for the vast number of pool shapes and sizes, disturbances produced by pool operation equipment (filters, pumps, etc.), and the random distribution in number and positioning of swimmers within them. Alert signals are commonly distorted or lost. Further, because external forces such as wind, rain, intruding debris, etc. can mimic the sound and movement of a swimmer, real emergencies can be obscured by a high frequency of false alarms.

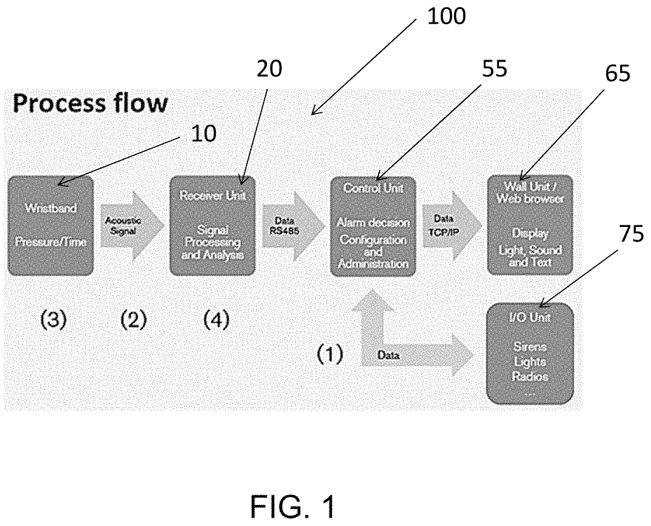

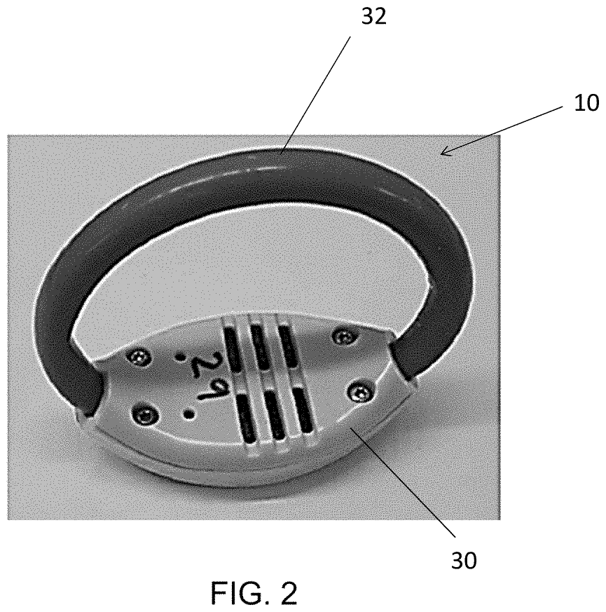

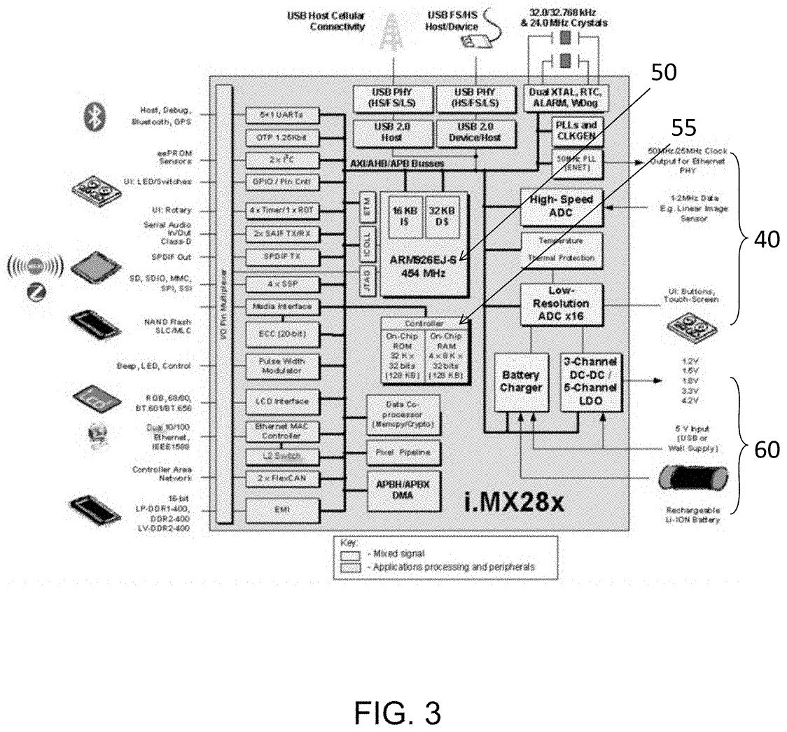

Referring now to FIG. 1, some embodiments of the disclosed subject matter are directed to a system 100 for monitoring an individual and generating an alarm if the individual is in distress. In some embodiments, the system 100 includes a wearable apparatus 10 in communication with a receiver unit 20. Referring now to FIG. 2, the wearable apparatus 10 is a wristband. In some embodiments, the wearable apparatus 10 is a belt, anklet, necklace, attachable dongle, article of clothing, etc. The wearable apparatus 10 depicted in FIGS. 2 and 3 includes a housing 30, a sensor 40, a signal generator 50, and a power source 60 (depicted in FIG. 3). In some embodiments, the housing 30 is at least water resistant. In some embodiments, the sensor 40 is a pressure sensor, temperature sensor, or a combination thereof. In the depicted embodiment, the signal generator 50 is configured to generate an alarm signal in response to an alarm condition. In some embodiments, the signal generator 50 is a vibration generator, a sound generator, a piezoelectric membrane, or a combination thereof. The power source 60, as depicted in FIG. 3, includes a rechargeable battery. In some embodiments, the wearable apparatus 10 includes an attachment apparatus 32 for securing it to an individual, e.g., a strap, clip, magnet, hook-and-loop fastener, etc.

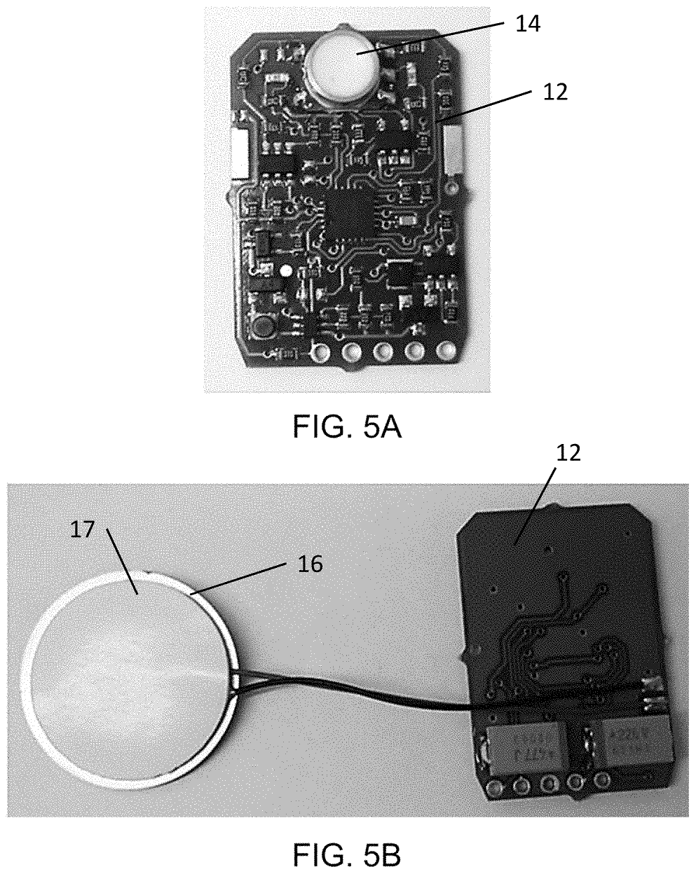

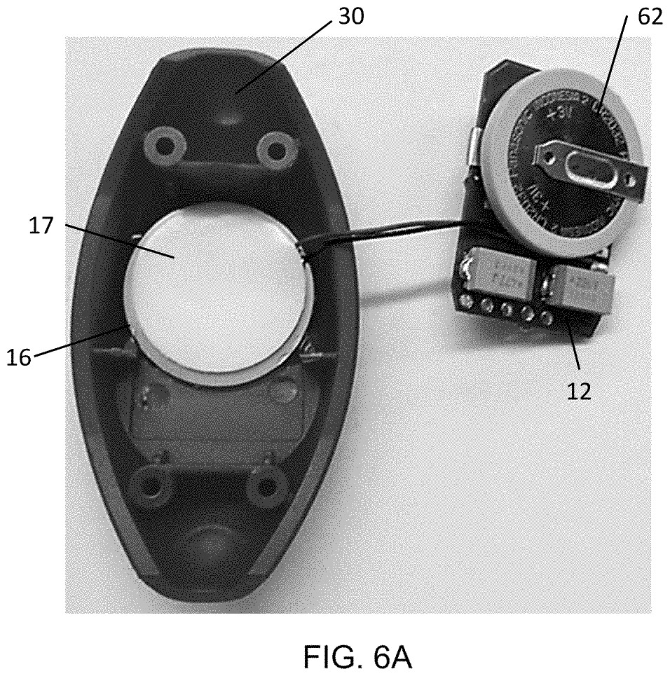

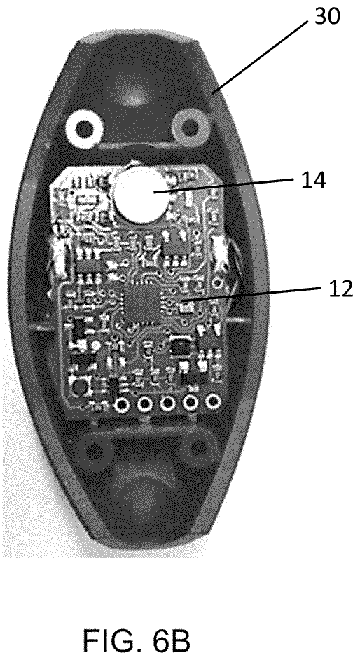

FIGS. 5A-6B depict the aforementioned elements during assembly of the wristband 10. A PC board 12 provides the circuitry and mounting points for pressure sensor 14 and piezo sounder 16. In the depicted embodiment, the piezo sounder 16 is mounted to foam pad 17. FIG. 6A depicts the piezo sounder 16 and foam pad 17 mounted in the housing 30. An internal battery 62 provides the power source 60. FIG. 6B depicts the PC board 12 in an installed state in the housing 30.

Referring again to FIG. 1, in some embodiments, the wearable apparatus 10 generates an alarm signal in response to an alarm condition that is received by the receiver unit 20. In some embodiments, the alarm signal is the generated vibration/sound as described above. In some embodiments, the alarm signal is emitted from the wearable apparatus 10 at a predetermined frequency. In some embodiments, the alarm signal is pulsed. In some embodiments, the alarm signal is continuously emitted until it is disabled. In some embodiments, the alarm signal is disabled by entering a PIN number into the system. In some embodiments, the frequency is between about 3 kHz and about 20 kHz. In some embodiments, the alarm signal is emitted at a plurality of frequencies. In some embodiments, the alarm signal is emitted at a plurality of frequencies simultaneously. In some embodiments, the alarm signal is emitted at a plurality of frequencies in a predefined sequence. In some embodiments, the alarm signal sweeps from a first frequency to a final frequency within a predefined amount of time. In some embodiments, as used herein, the alarm signal is “swept” by substantially continuously increasing and/or decreasing its frequency to a final frequency over the course of a certain amount of time, e.g., a minute, a second, a millisecond, a microsecond, etc. In some embodiments, as used herein, the alarm signal is “swept” by increasing and/or decreasing in discrete frequency increments, i.e., the signal is maintained at a certain frequency for a certain amount of time, then increased or decreased by an amount, e.g., 0.5 kHz, until a final frequency is reached. In some embodiments, the sweep signal oscillates between the first frequency and the final frequency. In some embodiments, the sweep oscillates randomly between lower and higher frequencies. In some embodiments, sweep oscillates between a plurality of lower and higher frequencies in a predetermined pattern. In some embodiments, this frequency sweep is repeated until the alarm signal is disabled.

In some embodiments, the wearable apparatus 10 is in communication with the receiver unit 20 via an environmental medium in which the system user is immersed, e.g., water or air. Alarm signals generated by the wearable apparatus 10 propagate through the environmental medium and the receiver unit 20 identifies and receives the alarm signals.

As discussed above depicted in FIGS. 5A-6B, in some embodiments, the wearable apparatus 10 includes a pressure sensor 14 and/or a temperature sensor, or a combination pressure and temperature sensor. The sensor 40 is configured to detect an alarm condition. Each sensor is calibrated to a baseline reading, i.e., baseline pressure and/or temperature. In some embodiments, once a sensor reading deviates from the baseline reading by a predefined amount, the wearable apparatus 10 begins to prepare to emit the alarm signal. If the deviation is maintained for a predetermined amount of time, then the alarm signal is emitted. In some embodiments, the sensor 40 is calibrated to recognize a pressure associated with a threshold depth within the environmental medium. Pressure readings by the sensor 40 beyond that threshold thus indicate that the wearer may be in distress. In some embodiments, the wearable apparatus 10 is physically brought to a target depth in an environmental medium and “zeroed” at that depth. Pressure and/or temperature readings at this depth then become the threshold. In some embodiments, the wearable apparatus 10 is removed from the environmental medium and “zeroed”. In these embodiments, insertion of the wearable apparatus 10 into the environmental medium results in a registerable pressure and/or temperature change that can be used as the threshold deviation to generate the alarm signal. Further, in these embodiments, a predetermined percentage depth of the environmental medium can be the threshold to generate the alarm signal. In some embodiments, the wearable apparatus 10 includes a “sleep mode” to save battery power. In these embodiments, if the sensors have not detected a deviation from the calibrated pressure/temperature, or the threshold, for a predetermined amount of time, the wearable apparatus 10 enters the sleep mode.

In some embodiments, a “wake pressure” is a positive pressure change that wakes up the wristband. In some embodiments, a “sleep pressure” occurs when the pressure change measured is less than a set sleep pressure and the temperature measured is less than a sleep temperature.

In some embodiments, if the minimum battery is under a certain voltage (i.e., 2 or 3 volts) the wristband beeps in accordance with the sleep rate.

In one embodiment, the measurement of conditions and alert last 60 seconds total. The wearable device 10 spends 20 “depth seconds” between a “depth start” and a “depth end” in a fluid (e.g., 8-10 feet underwater). The charging capacitor readies for firing an alert over the next 10 seconds. An audio beep then sounds. In some embodiments, there is no audio beep. The wearable device 10 then generates an alert for 30 seconds. In some embodiments, the wearable device 10 generates an alert for up to 256 seconds (4 minutes 10 seconds). In some embodiments the capacitor charges in up to four distinct steps. When the wearable device 10 detects a negative depth (i.e., not under fluid pressure, etc.) the wearable device 10 zeroes (the calculated pressure=the current pressure). In some embodiments the calculated pressure is determined incrementally, with one value every “update seconds.”

In some embodiments, the system includes two or more receiver units. In some embodiments, the receiver unit 20 is configured to identify the presence of an alarm signal. In some embodiments, the receiver unit 20 is configured to process the alarm signal. In some embodiments, the receiver unit 20 is configured to analyze the alarm signal. In some embodiments, the wearable apparatus 10 is in communication with the receiver unit 20 via a wired connection. In some embodiments, the wearable apparatus 10 is in communication with the receiver unit 20 via a wireless connection. In some embodiments, the receiver unit 20 includes at least two modes: a listening mode and an alarm mode. In listening mode, the receiver unit 20 awaits the detection of the alarm signal from the wearable apparatus 10. In alarm mode, the receiver unit 20 transmits the presence of a detected alarm signal.

In some embodiments, the receiver unit 20 is an aquatic diagnostic apparatus. In some embodiments, the receiver unit 20 is a hydrophone. The present disclosure discusses the system as installed in a body of water such as a pool, and as such the environmental medium is generally referred to herein as water. In some embodiments, the environmental medium is a public, hotel, paid attendance, or members-only swimming pool or body of water. However, in other embodiments, the environmental medium is any suitable liquid or gas. As discussed above, in some embodiments, the alarm signal is a vibration that is propagated through the environmental medium at a frequency that is identified by the receiver unit 20. In some embodiments, the receiver unit 20 can detect a variety of alarm signal frequencies. In some embodiments, a plurality of receiver units are separated into zones. By way of example, a plurality of receiver units can be included in the same pool, but with half of the receiver units positioned in a shallower end and the other half positioned in a deeper end. In some embodiments, the system's receiver units are spread across a plurality of environmental mediums. Again referring to the pool example, some of the plurality of receiver units can be positioned within a children's pool and the remaining receiver units can be positioned in the adult's pool in the same pool complex. Separating the receiver units into zones enables the alarm signals to better locate the source of an alarm signal, e.g., within a certain pool but not another, or within a certain location of a pool, thus saving precious time locating the exact location of the alarm signal.

Referring now to FIG. 3, in some embodiments, the system includes a control unit 55. In some embodiments, the receiver unit 20 is configured to transmit the presence of an alarm signal to a control unit 55. In some embodiments, the receiver unit 20 communicates with the control unit 55 via a wireless connection. In some embodiments, the receiver unit 20 communicates with the control unit 55 via a wired connection. In some embodiments, the control unit 55 includes one or more controllers. In some embodiments, the system and system settings are accessible and changeable via the control unit 55, e.g., alarm threshold settings, sensor reading deviation time triggers, etc. In some embodiments, the control unit 55 is connected to a local area network. In some embodiments, the local area network is wireless. In some embodiments, a user interacts with the control unit 55 via a web browser.

As discussed above, in some embodiments, the control unit 55 enables users to view and adjust system settings such as user management, network management, zone management, system logs, etc. In some embodiments, user management allows the input of additional users to the system, including additional wearable apparatus 10 to be monitored or additional supervisors who would be alerted in the event of an alarm. In some embodiments, network management allows the addition of components to the system, e.g., additional receiver units. In some embodiments, the additional components are added manually. In some embodiments, the presence of additional components are recognized and then added to the system automatically. In some embodiments, network management enables a user to assign a receiver unit 20 to a zone. In some embodiments, zone management allows the definition of new or revision of preexisting zones. In some embodiments, zone management enables receiver units to be added to or removed from a zone. In some embodiments, system logs detailing alarm history and system settings changes are accessible via the control unit 55. In some embodiments, the system settings changes include when the wearable apparatus 10 was recalibrated.

In some embodiments, the control unit 55 is configured to report system status to a user. In some embodiments, the system status includes an “all-clear” status and an alarm status. In some embodiments, the system status is displayed in a web browser. In some embodiments, the system status is displayed on a supervisor's smart device, e.g., a phone, tablet, watch, etc. In some embodiments, the system status is transmitted to a walky-talky. Thus, the supervisor can be alerted to an incident taking place in an environmental medium, e.g., a pool, even in instances where the incident is obscured from view or when the supervisor is off site. In some embodiments, the control unit 55 is in communication with an I/O unit 75. In some embodiments, the I/O unit 75 is configured to generate a visual, aural, or tactile alarm

In some embodiments, the control unit 55 is in communication with an alarm unit (herein also referred to as a “wall unit 65”). In some embodiments, the wall unit 65 communicates with the control unit 55 via a wireless connection. In some embodiments, the wall unit 65 communicates with the control unit 55 via a wired connection. In some embodiments, the wall unit 65 is connected to a local area network. In some embodiments, the local area network is wireless. In some embodiments, the wall unit 65 includes a display. In some embodiments, the system status is presented on the wall unit display. In some embodiments, the alarm signal is disabled by entering a PIN number into the wall display.

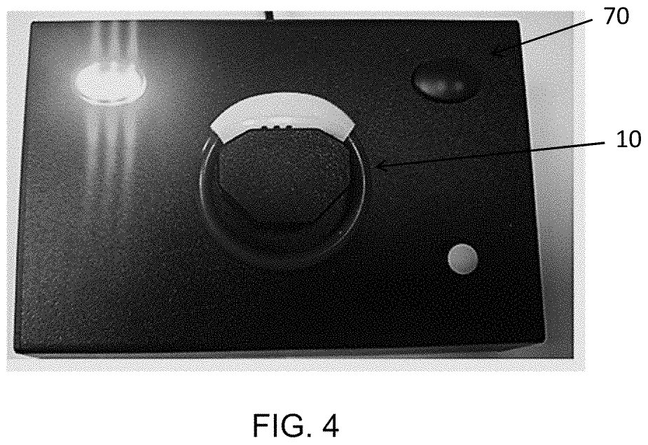

Referring now to FIG. 4, in some embodiments, the system includes a wearable apparatus 10 tester/programmer 70. In some embodiments, the tester/programmer 70 is a docking station allowing the wearable apparatus 10 to communicate with the control unit 55. In some embodiments, the wearable apparatus 10 tester/programmer 70 is configured to test battery level, test for software operability, update wearable apparatus software, update wearable apparatus 10 settings such as alarm trigger time, initiate updates to alarm trigger depth, etc., or a combination thereof.

Additional background and details regarding some embodiments of the present disclosure are included in as U.S. Publication No. 2008/0218332 and U.S. Pat. No. 5,195,060, which are incorporated herein by reference in their entireties.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

1. A system 100 for alerting a supervisor of an individual in distress, comprising:
a wearable apparatus 10 including a housing 30, a sensor 40, a signal generator 50, and a power source 60;
a receiver unit 20 in communication with the wearable apparatus 10 and configured to receive an alarm signal generated by the signal generator 50;
a control unit 55 in communication with the receiver unit 20 and the supervisor and configured to report a system status to the supervisor;
a wall unit 65 in communication with the control unit 55 and configured to display the system status;
wherein the alarm signal emits at a plurality of frequencies.

2. The system 100 according to claim 1, wherein the signal generator 50 is a piezoelectric membrane.

3. The system 100 according to claim 1, wherein the alarm signal sweeps from a first frequency to a final frequency.

4. The system 100 according to claim 3, wherein the alarm signal sweeps are repeated until the alarm signal is disabled.

5. The system 100 according to claim 3, wherein the alarm signal sweeps by increasing or decreasing in discrete frequency increments until a final frequency is reached.

6. The system 100 according to claim 1, wherein the alarm signal sweeps randomly between frequencies.

7. The system 100 according to claim 1, wherein the sensor 40 is a pressure sensor, a temperature sensor, or a combination thereof.

8. The system 100 according to claim 1, wherein the signal generator 50 is a vibration generator, a sound generator, a piezoelectric membrane, or a combination thereof.

9. The system 100 according to claim 1, further comprising two or more receiver units 20 in communication with the wearable apparatus 10.

10. The system 100 according to claim 1, further comprising an I/O unit 75 in communication with the control unit 55, wherein the I/O unit 75 is configured to generate a visual, aural, or tactile alarm.

11. The system 100 according to claim 1, further comprising a tester 70 that is configured to test battery level, test software operability, update wearable apparatus software, update wearable apparatus settings, or a combination thereof, the wearable apparatus settings include alarm trigger time and initiate updates to alarm trigger depth.

12. A method for alerting a supervisor of an individual in distress, comprising:
a system 100 including wearable apparatus 10 and a receiver unit 20, the wearable apparatus 10 having a signal generator 50 and a battery 62, the receiver unit 20 configured to receive an alarm signal generated by a signal generator 50; and
a control unit 55 in communication with the receiver unit 20 and the supervisor and configured to report a system status to the supervisor;
wherein the control unit 55 measures the system status and reports the system status to the supervisor every update period.

13. The method of claim 12, wherein the control unit 55 measures the system status and reports the system status to the supervisor when the system status remains in a depth range for a predetermined period.

14. The method of claim 12, wherein the update period becomes a sleep period if the system status indicates a pressure change measurement and a temperature measurement below a sleep reference.

15. The method of claim 14, wherein the sleep period becomes the update period if the system status indicates a positive pressure change or temperature change above a wake reference.

16. The method of claim 12, wherein the update period becomes a warning period if the system status indicates a battery voltage level below a warning reference.

17. The method of claim 16, wherein the signal generator 50 emits a signal every warning period to the supervisor until the system status indicates a battery voltage level above the warning reference.

18. The method of claim 12, further comprising two or more receiver units 20 in communication with the wearable apparatus 10.

19. The method of claim 12, further comprising an I/O unit 75 in communication with the control unit 55, wherein the I/O unit 75 is configured to generate a visual, aural, or tactile alarm.

20. The method of claim 12, further comprising a tester 70 that is configured to test battery level, test software operability, update wearable apparatus software, update wearable apparatus settings, or a combination thereof, the wearable apparatus settings include alarm trigger time and initiate updates to alarm trigger depth.
